(19) United States
(12) Patent Application Publication
(10) Pub. No.: US 2017/0053475 A1
(43) Pub. Date: Feb. 23, 2017

(54) GAMING MACHINE WITH CURVED VIDEO DISPLAY

(71) Applicants: Milo Borissov, Dubai Sports City (AE); Rossi McKee, Indianapolis, IN (US)

(72) Inventors: Milo Borissov, Dubai Sports City (AE); Rossi McKee, Indianapolis, IN (US)

(21) Appl. No.: 14/829,629

(22) Filed: Aug. 18, 2015

(51) Int. Cl. G07F 17/32

(52) U.S. Cl. CPC G07F 17/3211; G07F 17/3244; G07F 17/3225

(57) ABSTRACT

A gaming machine has a curved electronic display. The display may be mounted in a corresponding curved housing. The display and housing have a radius of curvature about a vertical axis, e.g. are each located in a curved vertical plane. So arranged, the sides of the display and housing extend forwardly towards a player as compared to a middle portion of the display and housing, such as by extending forwardly towards the player from a generally flat vertical plane which intersects the curved plane between the sides of the display and housing.

### FIELD OF THE INVENTION

The present invention relates to gaming machines which are configured to present wagering games.

### BACKGROUND OF THE INVENTION

A variety of configurations of gaming machines which are designed to present wagering games are known. For example, some gaming machines include one or more physical reels which are configured to rotate or spin to present the outcome of what is known as a “slot” type game. Other gaming machines may utilize one or more electronic video displays to present game information.

A variety of problems exist with current gaming machines. One problem is that newer games are designed to present more information to the game player. Newer gaming machines thus often utilize larger displays to present the increased amount of information. However, when a player sits in front of those gaming machines, the player often has difficulty viewing the entire video display(s). This may force the player to scan their eyes around the video display(s) to see all of the displayed game content, thus slowing the pace of the game and/or making game play cumbersome to the player.

Also, players are often very sensitive to other players viewing their game play. It is generally viewed as socially unacceptable to hover over or behind a player while they are playing a game. However as gaming machines have become larger, the configuration of the gaming machine makes it easy for third parties to view the activities of the player.

### SUMMARY OF THE INVENTION

One aspect of the invention is a gaming machine having a curved display. Another embodiment of the invention is a gaming machine having a curved housing.

In one embodiment of the invention, a gaming machine has a curved display. At least a display face or front of the display is curved between its sides, e.g. is concave relative to a plane containing its opposing sides. In a preferred embodiment, the display is oriented so that it is in a vertical plane which has a radius of curvature about a vertical axis. In this manner, first and second sides of the display extend forwardly from a middle portion thereof, such as relative to a generally flat vertical plane which passes through the display between its first and second sides.

The display is mounted to or supported by a housing. In one embodiment, the housing, or at least a front thereof, is also curved. The housing may be located in a curved vertical plane which also has a radius of curvature about a vertical axis. The radius of curvature of the housing (or at least the front thereof) and the display (or at least the display face thereof) may be the same. The housing preferably has a reduced depth compared to a height and width thereof.

The gaming machine may include other features. For example, the gaming machine may include a console which extends forwardly from a front of the housing. The gaming machine may include a wager accepting device, one or more player input devices and at least one controller configured to receive input from the wager accepting device, the one or more player input devices and be configured to cause the display to present wagering game information. The gaming machine may also include other display devices such as other electronic displays, spinning slot reels or the like.

Further objects, features, and advantages of the present invention over the prior art will become apparent from the detailed description of the drawings which follows, when considered with the attached figures.

### DESCRIPTION OF THE DRAWINGS

FIG. 1 is a front perspective view of a gaming machine in accordance with an embodiment of the invention;

FIG. 2 is a rear perspective view of the gaming machine illustrated in FIG. 1;

FIG. 3 is a top view of the gaming machine illustrated in FIG. 1;

FIG. 4 is a front view of the gaming machine illustrated in FIG. 1;

FIG. 5 a first side view of the gaming machine illustrated in FIG. 1; and

FIGS. 6A, 6B and 6C illustrate alternate embodiments of gaming machines in accordance with the present invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention comprise gaming machines and features or configurations of gaming machines. In a preferred embodiment, the gaming machine is a wagering gaming machine, e.g. one which is configured to present one or more wager-based games.

The gaming machine may be located at a casino (and as such may be referred to as a “casino gaming machine”), but might be used or located at other locations. As described below, the gaming machine may be part of a gaming system, such as a casino gaming system which links two or more of the gaming machines or one or more gaming machines with other devices, such as one or more table games, kiosks, accounting systems or servers, progressive systems or servers, player tracking systems or servers or the like.

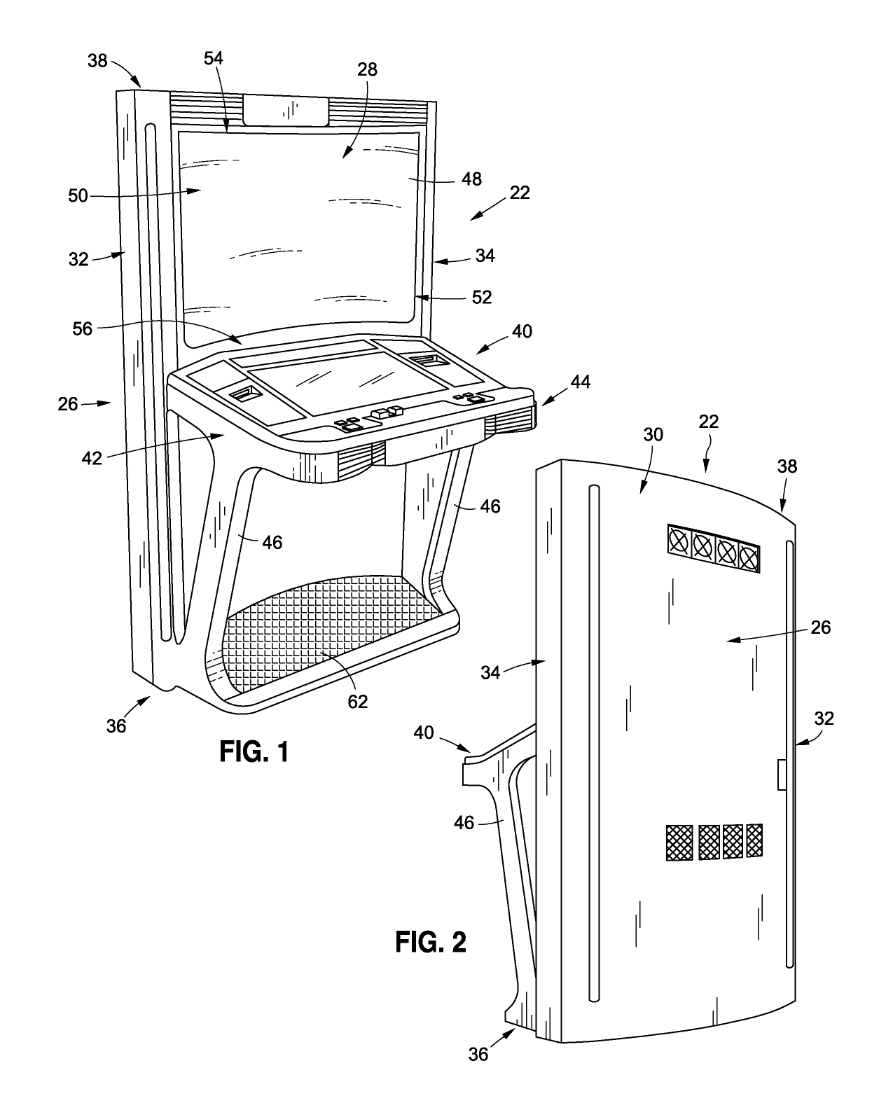

One embodiment of a gaming machine 22 is illustrated in FIG. 1. As illustrated, the gaming machine 22 generally comprises a housing or cabinet 26 for supporting and/or enclosing various components required for operation of the gaming machine. In the embodiment illustrated, the housing 26 generally has a front 28, a generally opposing rear 30, a first side 32, an opposing second side 34, and a bottom 36 and a top 38. In use, a player faces a front of the gaming machine 22, and thus the front 28 of the housing 26. The bottom 36 is designed to rest upon a supporting surface, such as a casino floor or a gaming machine stand. The height of the housing 26 to the top 38 may vary.

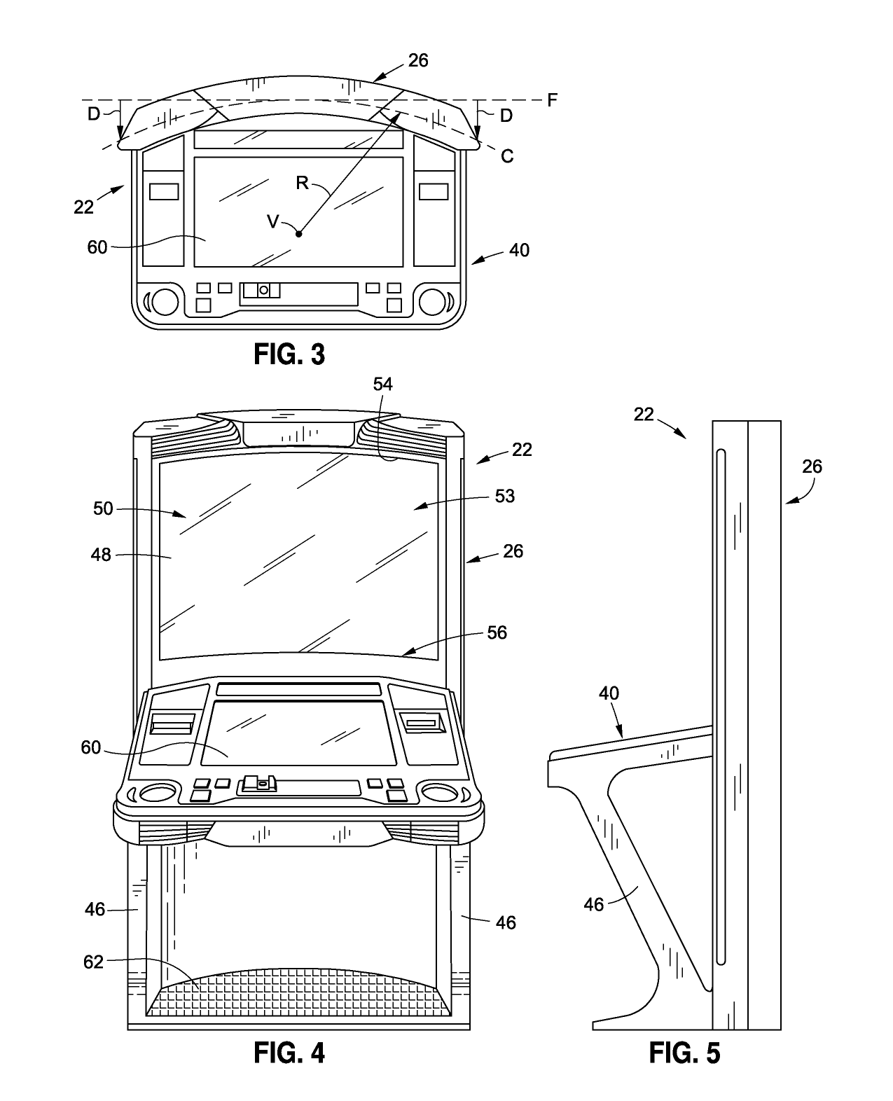

As best illustrated in FIGS. 3 and 5, in a preferred embodiment a depth of a main portion of the housing 26 from front 28 to rear 30 is reduced compared to the width and height of the cabinet 26. For reasons described below, in a preferred embodiment as illustrated in FIG. 3, the housing 26 is curved between its first and second sides 32,34. In one embodiment, the housing 26 (preferably generally the entire housing, including both the front 28 and rear 30, but at least the front 28) is concave relative to a plane which contains the first and second sides 28,30. In one embodiment, the housing 26 (or at least the front thereof) has a radius of curvature R about a generally vertical axis V which is located forwardly of the housing 26, thus causing the housing 26 to be located in/extend parallel to a curved vertical plane C which is offset from a flat vertical plane F which intersects the curved vertical plane C at its vertex.

In one embodiment, and as best illustrated in FIGS. 1, 3 and 4, the gaming machine 22 includes a console 40. As described below, the console 40 may support various input and/or output devices and/or include other features.

The console 40 may be part of the housing 26 or be connected to the housing 26. In the embodiment which is illustrated, the console 40 extends outwardly from the front 28 of the housing 26 at the front of the gaming machine 22. In one embodiment, the console 40 may have a first side 42 corresponding to the first side 32 of the housing 26, and a second side 44 corresponding to the second side 34 of the housing 26. The first and second sides 42,44 of the console 40 are preferably located inside (e.g. do not protrude outwardly beyond) the first and second sides 32,34 of the housing 26.

The console 40 is preferably raised, e.g. is located above a supporting surface for the gaming machine 22. In the embodiment illustrated, the console 40 is positioned generally midway between the bottom 36 and top 38 of the housing 26. However, the height of the console 40 is preferably selected for ease of player use, such as with reference to the position of a player seated on a seat in front of the gaming machine 22 (thus, the height of the seat which is utilized is a factor in determining the height of the console 40).

In the embodiment illustrated, the console 40 may be partially supported by one or more struts 46 or other supports. The location and design of the struts 46 or other supports may vary.

The gaming machine 22 preferably includes at least one display device configured to display game information. Referring to FIGS. 1 and 4, the gaming machine 22 preferably includes a main display 48 which comprises a curved screen electronic display. As illustrated in FIG. 3, the main display 48 is preferably oriented so that a radius of curvature R thereof is about a vertical axis V.

The main display 48 preferably comprises a generally thin electronic video display such as a high resolution flat panel liquid crystal display (LCD), projection LCD, plasma display, field emission display, digital micro-mirror display (DMD), digital light processing display (DLP), LCD touchscreen, a light emitting display (LED) or the like. The display 48 may be capable of projecting or displaying a wide variety of information, including images, symbols and other indicia or information associated with game play, game promotion or other events.

In the preferred embodiment, the main display 48 is a curved screen display, e.g. has at least a display face which is curved rather than generally flat. In this configuration, the main display 48 has a first side 50, a generally opposing second side 52, a top 54 and a bottom 56. As illustrated, the main display 48 has sides which are generally straight and perpendicular to one another, but the configuration of the display 48 might vary (such as by having non-linear sides). Most importantly, the main display 48 (or at least a front/display face thereof) is preferably curved between its first and second sides 50,52. In particular, the main display 48 is concave relative to a plane which contains the first and second sides 50,52 thereof. In a preferred embodiment, the display 48 is oriented to have a radius of curvature R about a vertical axis V. In this configuration, when a player views the main display 48 (from a front or display side thereof), the first and second sides 50,52 are closer to the player than would be the case if the screen were flat. For example, as illustrated in FIG. 3, the main display 48 may lie in a curved vertical plane C which intersects (such as at a middle of the display 48 between its sides 50,52 or at a vertex of the plane C) a flat vertical plane F, thus causing the first and second sides 50,52 of the main display 48 to be positioned forwardly of (e.g. in the direction of the front of the gaming machine 22) the flat vertical plane F, such as by a distance D.

The radius of curvature R might vary and may be uniform or might vary across the display from the first side 50 to the second side 52.

Most importantly, the main display 48 is preferably associated with the housing 26 so that it is oriented so that its first and second sides 50,52 curve inwardly towards the front 28 of the gaming machine 22 (and thus towards a player sitting in front of the gaming machine and facing the gaming machine). As illustrated, the main display 48 is located in or supported by the housing 26 and faces outwardly of the front 28 of the housing 26. The main display 48 is preferably positioned above the console 40. In this configuration, the main display 28 curved about a generally vertical axis V. This axis may be the same axis V as the housing 26 curves about. In a preferred embodiment as illustrated, the radius of curvature R of the main display 48 and the housing 26 are generally the same whereby a display face of the display and the front of the housing generally lie in the same plane. In other embodiments, they might differ (and as described below, for example, a curved display of the present invention might be used with a gaming machine 22 having a housing 28 which is not curved).

In a preferred embodiment, the main display 48 has a width between its first and second sides 50,52 which is greater than its height between its top 54 and bottom 56, e.g. it is rectangular in shape and is oriented in “landscape” orientation (where the longer width dimension extends in a horizontal direction and the shorter height dimension extends in the vertical direction). However, it is possible for the main display 28 to still be curved and oriented about a vertical axis as indicated herein, but have a width and height which are approximately the same or a height which is greater than its width.

The gaming machine 22 might include more than one display device, such as two or more displays which are associated with the housing 26. For example, the gaming machine 22 might have a single curved main display 48 as detailed above and one or more additional display devices. Those display devices might be electronic video displays or other devices (such as wheels, reels, etc.). Further, when the display devices comprise electronic video displays, they may or may not be curved. For example, as described below, one or more generally planar electronic video displays may be associated with the console 40. Also, the gaming machine 22 might include a top box or other portion. Such a top box might include one or more display devices. Also, the gaming machine 22 might include side displays (such as mounted to the exterior of the housing 26) and might include multiple displays of differing sizes.

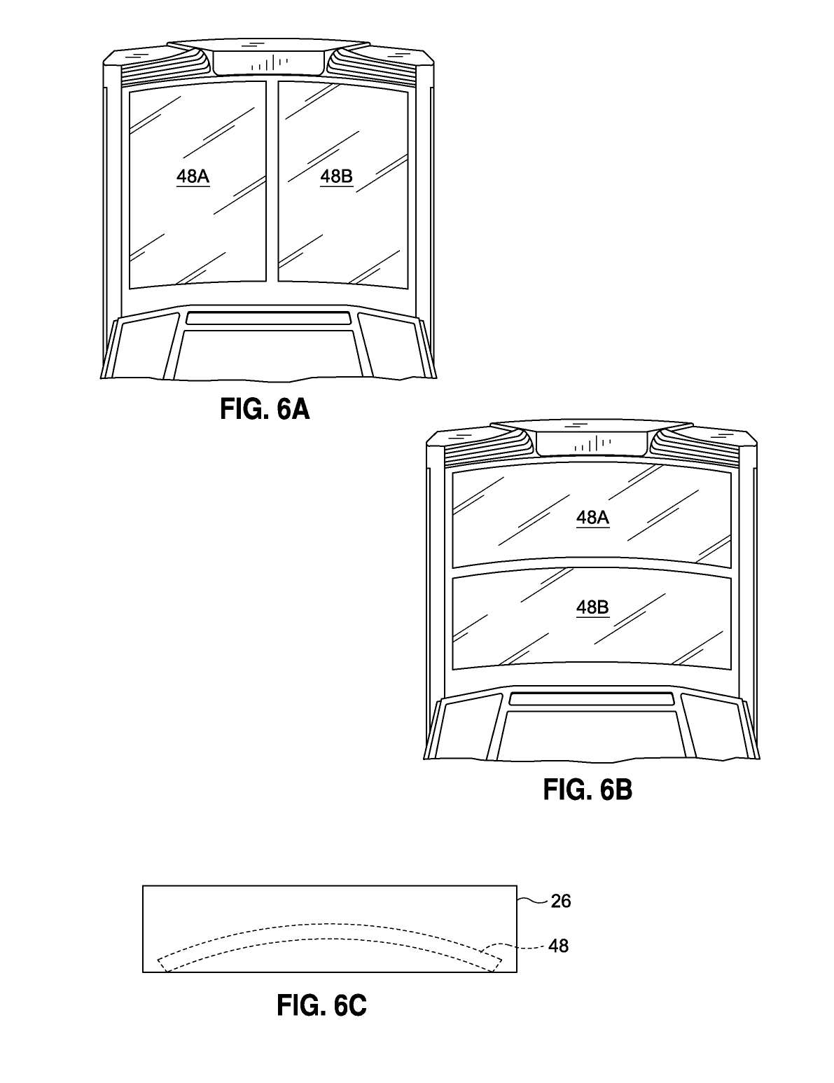

As another example, the gaming machine 22 might include two or more main displays 48 (or a first main display and at least one secondary display). For example, as illustrated in FIG. 6A, a first display 48A and a second display 48B might be oriented side by side (wherein again, preferably at least one, if not both, displays are curved displays; the displays might have the same radius of curvature or different curvatures and may or may not be the same size). In another embodiment, a first display 48A and a second display 48B might be located above one another (where again, preferably at least one, if not both, displays are curved displays which are oriented as described above; the displays might have the same radius of curvature or different curvatures and may or may not be the same size).

As described in more detail below, the gaming machine 22 is preferably configured to present one or more games upon a player making a monetary payment or wager. In this regard, as described in more detail below, the gaming machine 22 includes means for accepting monetary value.

In one embodiment, certain game outcomes may be designated as winning outcomes. Prizes or awards may be provided for winning outcomes, such as monetary payments (or representations thereof, such as prize of credits), or promotional awards as detailed herein. As detailed below, the gaming machine 22 includes means for returning unused monetary funds and/or dispensing winnings to a player.

The gaming machine 22 preferably includes one or more player input devices (such as input buttons, plunger mechanisms, a touch-screen display, joystick, touch-pad or the like). These one or more devices may be utilized by the player to facilitate game play, such as by providing input or instruction to the gaming machine 22. For example, such input devices may be utilized by a player to place a wager, cause the gaming machine 22 to initiate a game, to indicate game selections (cards to be held, etc.), to “cash out” of the gaming machine, or to provide various other inputs.

In one preferred embodiment, the gaming machine 22 includes at least one microprocessor or controller for controlling the gaming machine, including receiving player input and sending output signals for controlling the various components of the machine 22 (such as generating game information for display by the main display 48). The controller may be arranged to receive information regarding funds provided by a player to the gaming machine, receive input such as a purchase/bet signal when a purchase/bet button is depressed, and receive other inputs from a player. The controller may be arranged to generate information regarding a game, such as generating game information for display by the at least one main display 48, for determining winning or losing game outcomes and for displaying information regarding awards for winning game outcomes, among other things. Information/data may be exchanged between the at least one controller and the various peripherals or other devices via various communication links, including back planes, busses, etc.

The controller may be configured to execute machine readable code or “software” or otherwise process information, such as obtained from a remote server. Software or other instructions may be stored on a memory or data storage device. The memory may also store other information, such as pay table information. The gaming machine 22 may also include one or more random number generators for generating random numbers, such as for use in selecting slot symbols, cards or other game symbols used in the game and for presenting the game in a random fashion (e.g. whereby the game is presented in a manner in which the player cannot control the outcome).

Preferably, the controller is configured to execute machine readable code or instructions which are configured to implement the method of game play of the invention. For example, the controller of the gaming machine 22 may be configured to detect a wager, such as a signal from a player's depressing of the “bet one” button. Upon such an event and/or the player otherwise signaling the gaming machine to present the game, the controller may be configured to cause game symbols or other game information to be displayed on the at least one display 28. The controller may accept input from a player of game inputs, such as a request to spin reels or the like, via the one or more player input devices of the gaming machine 22.

The gaming machine 22 may be configured to generate and present games in a stand-alone manner or it may be in communication with one or more external devices at one or more times. For example, the gaming machine 22 may be configured as a server based device and obtain game code or game outcome information from a remote game server (in which event the gaming machine controller may receive game information from the server, such as game outcome information, and use that server-generated information to present the game at the gaming machine). In such a configuration it will be noted that the term “controller” may comprise more than one device. For example, in a server-based environment, a controller at a server may generate game information and transmit that information to a local controller at a gaming machine or a player's computer or other electronic device. The local controller at the gaming machine or the player's computer or other electronic device may then cause game information to be displayed on one or more associated displays.

As indicated, the gaming machine 22 is configured to present one or more wagering games. Thus, the gaming machines 22 is preferably configured to accept value, such as in the form of coins, tokens, paper currency or other elements or devices representing value such as monetary funds. For example, the gaming machine 22 might include a coin acceptor (not shown) for accepting coins. Of course, associated coin reading/verifying devices and coin storage devices may be associated with the gaming machine 22 if it is configured to accept coins. Likewise, the gaming machine 22 might include a media reader (not shown). Such a reader may be configured to accept and read/verify paper currency and/or other media such as tickets. Of course, in such event the gaming machine 22 may further be configured with one or more paper currency or ticket storage devices, such as cash boxes, and other paper currency or media handling devices (including transport devices).

The gaming machine 22 might also be configured to read FOBs, magnetic stripe cards or other media having data associated therewith and via which value or funds may be associated with the gaming machine 22.

In one embodiment, the gaming machine 22 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. For example, upon an award or at cash-out, associated funds may be paid to the player by the gaming machine 22 dispensing coins to a coin tray. In another embodiment, funds may be issued by dispensing paper currency. In yet another embodiment, a player may be issued a media, such as a printed ticket, which ticket represents the value which was paid or cashed out of the machine. The aspects of gaming machine “ticketing” systems are well known. One such system is described in U.S. Pat. No. 6,048,269 to Burns, which is incorporated herein in its entirety by reference.

The gaming machine 22 may also include a player tracking device, such as a card reader (not shown) and associated keypad (not shown). Such player tracking devices are well known and may permit the game operator to track play of players of the gaming machine. The tracked play may be utilized to offer player bonuses or awards.

As indicated, such features may be supported by or associated with the housing 26, including the console 40. The features might be mounted in or be attached to (including mounted to the exterior of) the housing 26 and/or console 40. For example, as best illustrated in FIGS. 3 and 4, the console 40 supports a secondary display 60 and/or other features.

The secondary display 60 may be configured to display main game information, secondary game information and/or other information, such as player related information or the like. The secondary display 60 might include or be associated with a touch screen so as to be able to receive player input.

The gaming machine 22 may include other features. For example, the gaming machine 22 may include a footrest 62. As illustrated in FIGS. 1 and 4, the footrest 62 is located below the console 40 and may be extend forwardly from a front of the housing 26.

A casino may have numerous such gaming machines 22, such as located on a casino floor or in other locations. Of course, such gaming machines 22 might be used in other environments, such as an airport, a bar or tavern or other locations.

It will be appreciated that the gaming machine illustrated in FIG. 1 is only exemplary of one embodiment of a gaming machine. For example, it is possible to for the gaming machine to have various other configurations, including different shapes and styles and having different components than as just described. For example, the gaming machine 22 could have other configurations, shapes or dimensions (such as being of a “slant”-type or other configuration as is well known to those of skill in the art). In such a configuration, the housing and/or display may not extend in a vertical plane, but in one which is offset from the horizontal. For example, the display might be located in a plane which is offset from vertical by 45 degrees. In such a configuration, the display is still preferably curved, but extends about an axis which is also tilted (in this regard, the display and/or housing of the invention may have the desired curvature with sides which extend inwardly or forwardly by having a radius of curvature relative to an axis which extends parallel to the sides and/or perpendicular to the top and bottom thereof).

It will be appreciated that individual features of the invention may be used in other environments or applications. For example, instead of using a curved main display with a curved gaming machine housing as described above, the curved main display could be used with gaming machines or housings having other configurations. As one example, the gaming machine housing might be box-like and have a generally planar front. A curved main display might be mounted in or to such a gaming machine housing, such as illustrated in FIG. 6C.

In one embodiment, the curved screen display is referred to as a main display because it is the predominant display by location and size and is used to present the primary information for games presented at the gaming machine 22. However, the at least one curved display might comprise a secondary display and/or be configured to display other information. For example, in the embodiment illustrated in FIG. 4, primary or main game information might be displayed by the console display(s) 60, and secondary or other information (such as bonus events, etc.) might be displayed via the main display 48.

The invention has numerous advantages. One advantage of the invention is a gaming machine having a curved screen display. The display is preferably oriented so that it is generally located in a vertical plane and curves about a vertical axis, e.g. so that sides of the display curve forwardly towards a viewer (as compared to a middle portion of the display). This orientation/configuration facilitates viewing of content by a player. In particular, the side portions of the display angle towards the player, thus keeping those portions of the display closer to perpendicular in viewing angle to the player than if, for example, the display were flat and located in a flat plane F. Thus, the content of information displayed across the display is more readily viewable by the player, reducing the time necessary to the player to see the information and reducing the work necessary for the player to see the information.

The thin dimension of the gaming machine also reduces footprint size of the gaming machine, allowing more gaming machines to be located in a fixed spaced (as compared to traditional gaming machines which have a deep housing (e.g. one where the width and depth are generally the same). Further, the curved housing makes the gaming machine 22 more ergonomic and player-friendly, as well as making the gaming machine more “personal” in configuration (since the sides of the gaming machine wrap inwardly towards the player, forming a semi-enclosed gaming area for the player.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A gaming machine comprising:
a housing, said housing having a first side, a second side, a top, a bottom, a front and a rear;
at least one electronic video display supported by said housing, said at least one main display having a curved display face, said at least one main electronic video display oriented so that a radius of curvature of said display face is about a vertical axis, whereby a first and a second side thereof are located forwardly of a flat vertical plane which intersects said display face between said first and second sides thereof;
at least one wager accepting device; and
at least one controller configured to execute machine readable code fixed in a tangible medium to cause said at least one main electronic video display to display wagering game information.

2. The gaming machine in accordance with claim 1 wherein said housing is curved between said first and second sides thereof.

3. The gaming machine in accordance with claim 2 wherein said housing has a radius of curvature which is generally the same as said radius of curvature of said display face.

4. The gaming machine in accordance with claim 1 wherein a length of said at least one electronic video display between said first and second sides is greater than a height of said at least one electronic video display between a top and bottom thereof.

5. The gaming machine in accordance with claim 1 wherein said at least one electronic video display comprises a generally planar electronic display.

6. The gaming machine in accordance with claim 1 further comprising a console, said console extending forwardly of said front of said housing.

7. The gaming machine in accordance with claim 6 wherein said at least one electronic video display is positioned above said console.

8. The gaming machine in accordance with claim 6 further comprising at least one second video display associated with said console.

9. The gaming machine in accordance with claim 1 further comprising one or more player input devices.

10. A gaming machine comprising:
a housing having a first side, a generally opposing second side, a top, a generally opposing bottom, a front and a generally opposing rear, a thickness dimension between said front and rear being reduced as compared to a width dimension between said first and second sides and a height dimension between said top and bottom, said housing being curved between said first and second sides, said housing located in a generally vertical plane having a first radius of curvature about a first vertical axis;
a console extending forwardly from said front of said housing between said top and said bottom thereof;
a main electronic display mounted to said housing, said main electronic display located above said console and having a first side, an opposing second side, a top and an opposing bottom, said main electronic display curved between said first and second sides thereof, said display located in a generally vertical plane having a second radius of curvature about a second vertical axis;
at least one wager accepting device;
at least one player input device; and
at least one controller configured to receive input from said at least one wager accepting device of at least one wager and input from said at least one player input device and configured to cause said main electronic display to present wagering game information.

11. The gaming machine in accordance with claim 10 wherein said first and second radius of curvature are the same.

12. The gaming machine in accordance with claim 10 wherein said first and second vertical axis are the same.

13. The gaming machine in accordance with claim 10 wherein a width of said main electronic display between said first and second sides thereof is greater than a height thereof between said top and bottom.
